(19) United States
(12) Patent Application Publication
(10) Pub. No.: US 2013/0073342 A1
(43) Pub. Date: Mar. 21, 2013

(54) COMPUTER-BASED SYSTEM AND METHOD FOR NEGOTIATING A PRICE

(71) Applicants: Jeffery Scott Crump, Spring, TX (US); Stacy Borden Pitts, Spring, TX (US)

(72) Inventors: Jeffery Scott Crump, Spring, TX (US); Stacy Borden Pitts, Spring, TX (US)

(21) Appl. No.: 13/622,687

(22) Filed: Sep. 19, 2012

Related U.S. Application Data
(60) Provisional application No. 61/536,248, filed on Sep. 19, 2011.

(51) Int. Cl. G06Q 30/00; G06Q 30/02

(52) U.S. Cl. 705/7.35; 705/26.1

(57) ABSTRACT

A computer-based method for negotiating a price, including: storing, in at least one memory element of at least one computer, computer readable instructions; and, executing, using at least one processor for the at least one computer, the computer readable instructions to: generate a target price for a first item available for purchase at a first retail sales location for a business entity; generate a plurality of offers greater than the target price; and implement at least one iteration of a sequence including: transmitting a respective offer from the plurality of offers; receiving, from a first wireless communications device (WCD) in the first retail sales location, a respective counter-offer less than the respective offer; and transmitting, for receipt by the first WCD: a rejection of the respective counter-offer; an acceptance of the respective counter-offer; or a message that a negotiation for the first item is terminated.

### CROSS-REFERENCE TO RELATED APPLICATIONS

This application claims the benefit under 35 U.S.C. §119(e) of U.S. Provisional Application No. 61/536,248, filed Sep. 19, 2011 and is incorporated herein by reference in its entirety.

### TECHNICAL FIELD

The present disclosure relates generally to a computer-based system and method for bargaining and more particularly a computer-based system and method for providing retailers with an automated means for negotiating, with an in-store shopper, an option to purchase goods and services at an agreed upon price without the shopper incurring a premium or an obligation to buy, and which expires when the shopper leaves the store.

### BACKGROUND

In the mid nineteenth century retailers began offering goods at fixed prices with guarantees that allowed exchanges and refunds, as well as providing a means of attracting shoppers with advertised prices. Gradually the traditional savings resulting from bargaining over price was traded for convenience and the art of negotiating atrophied.

Presently retailers expend considerable effort and resources getting shoppers into their stores only to miss an opportunity in generating revenues, earning profits, and moving inventory if a shopper decides against purchasing a desired item because the price is perceived to be too high.

The shopper is faced with the dilemma of purchasing the item where they are currently shopping at a perceived higher price versus traveling to another retailer incurring some costs and possibly paying less. Some price conscious shoppers seek out in advance the best prices by reviewing published materials before traveling to a retailer, but it is not always practical to search on more than a few items before the costs associated with traveling between retailers consumes the perceived savings.

Some specialized retailers, such as antiques dealers, still negotiate directly with shoppers over price. However, it is not cost effective nor is it practical to do so for most retailers because they have a high ratio of shoppers to authorized and qualified negotiators.

### SUMMARY

According to aspects illustrated herein, there is provided a computer-based method for negotiating a price, including: storing, in at least one memory element of at least one computer, computer readable instructions; and, executing, using at least one processor for the at least one computer, the computer readable instructions to: generate a target price for a first item available for purchase at a first retail sales location for a business entity; generate a plurality of offers greater than the target price; and implement at least one iteration of a sequence including: transmitting a respective offer from the plurality of offers; receiving, from a first wireless communications device (WCD) in the first retail sales location, a respective counter-offer less than the respective offer; and transmitting, for receipt by the first WCD: a rejection of the respective counter-offer; an acceptance of the respective counter-offer; or a message that a negotiation for the first item is terminated.

According to aspects illustrated herein, there is provided a computer-based system for a computer-based system for negotiating a price, including at least one memory element of at least one computer configured to store computer readable instructions and at least one processor for the at least one computer arranged to execute the computer readable instructions to: generate a target price for a first item available for purchase at a first retail sales location for a business entity; generate a plurality of offers greater than the target price; and implement at least one iteration of a sequence including: transmitting a respective offer from the plurality of offers; receiving, from a first wireless communications device (WCD) in the first retail sales location, a respective counter-offer less than the respective offer; and transmitting, for receipt by the first WCD: a rejection of the respective counter-offer; an acceptance of the respective counter-offer; or a message that a negotiation for the first item is terminated.

According to aspects illustrated herein, there is provided a computer-based system for negotiating a price, comprising: at least one memory element of at least one computer configured to store computer readable instructions; and at least one processor for the at least one computer configured to execute the computer readable instructions to: generate a sales history for a first item, available for purchase at a first retail sales location, over a first time period; accept a selection of sale of units of the first item as an economic parameter; accept a selection of sale of a specified number of units of the first item within a second time period as a condition of the economic parameter; generate a target price for the first item; generate a plurality of offers greater than the target price; and implement at least one iteration of a sequence including: transmitting a respective offer from the plurality of offers; receiving, from a wireless communications device (WCD) in the first retail sales location, a respective counter-offer less than the respective offer; and transmitting, for receipt by the WCD: a rejection of the respective counter-offer; an acceptance of the respective counter-offer; or a message that a negotiation for the first item is terminated. The sales history includes: purchases of the first item based on respective accepted counter-offers; and a respective price for each purchase. Generating the target price includes: generating a function from the sales history including: a first variable representing respective prices paid per unit of the first item; and a second variable representing respective numbers of units of the first item sold per the second time period. Generating the target price includes: determining a first value of the first variable at which the condition of the economic parameter is satisfied by selecting a second value for the second variable corresponding to the specified number of units; and selecting the first value as corresponding to the second value in the function. Generating the target price includes selecting the first value as the target price.

According to aspects illustrated herein, there is provided a computer-based system for negotiating a price, including: at least one memory element of at least one computer configured to store computer readable instructions; and at least one processor for the at least one computer configured to execute the computer readable instructions to: generate a sales history for a first item, available for purchase at a first retail sales location, over a first time period; accept a selection of a specified amount of revenue from sales of the first item as an economic parameter; accept a selection of the specified amount of revenue within a second time period as a condition of the economic parameter; generate a target price for the first item; generate a plurality of offers greater than the target price; and implement at least one iteration of a sequence including: transmitting a respective offer from the plurality of offers; receiving, from a wireless communications device (WCD) in the first retail sales location, a respective counter-offer less than the respective offer; and transmitting, for receipt by the WCD: a rejection of the respective counter-offer; an acceptance of the respective counter-offer; or a message that a negotiation for the first item is terminated. The sales history includes: purchases of the first item based on respective accepted counter-offers; and a respective price for each purchase. Generating a target price includes: generating a function from the sales history including: a first variable representing respective prices paid per unit of the first item, and a second variable representing respective revenues generated per value of the first variable; determining a first value of the first variable at which the condition of the economic parameter is satisfied by: selecting a second value for the second variable corresponding to the specified amount of the revenue and selecting the first value as corresponding to the second value in the function; and selecting the first value as the target price.

According to aspects illustrated herein, there is provided a computer-based system for negotiating a price, including: at least one memory element of at least one computer configured to store computer readable instructions; and at least one processor for the at least one computer configured to execute the computer readable instructions to: generate a sales history for a first item, available for purchase at a first retail sales location, over a first time period; accept a selection of the specified profit within a second time period as an economic parameter; accept a selection of sale of a specified number of units of the first item within a second time period as a condition of the economic parameter; generate a target price for the first item; generate a plurality of offers greater than the target price; and implement at least one iteration of a sequence including: transmitting a respective offer from the plurality of offers; receiving, from a wireless communications device (WCD) in the first retail sales location, a respective counter-offer less than the respective offer; and transmitting, for receipt by the WCD: a rejection of the respective counter-offer; an acceptance of the respective counter-offer; or a message that a negotiation for the first item is terminated. The sales history includes: purchases of the first item based on respective accepted counter-offers; and a respective price for each purchase. Generating a target price includes: generating a function from the sales history including: a first variable representing respective prices paid per unit of the first item and a second variable representing respective profits generated per value of the first variable; determining a first value of the first variable at which the condition of the economic parameter is satisfied by: selecting a second value for the second variable corresponding to the specified profit a second variable representing respective profits generated per value of the first variable; and selecting the first value as corresponding to the second value in the function; and selecting the first value as the target price.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a schematic block diagram of a computer-based system for negotiating a price;

FIG. 2 is an illustration of an example negotiation strategy for the system shown in FIG. 1;

FIGS. 3A through 3C are respective example illustration of respective economic basis for target price selections;

FIG. 4 is an illustration of an example distributed computer-based system for negotiating a price;

FIG. 5 is a photograph of a screen illustrating a start menu for a computer-based system for negotiating a price;

FIG. 6 is a photograph of a screen illustrating a main menu for a computer-based system for negotiating a price;

FIG. 7 is a photograph of a screen illustrating a scan for a computer-based system for negotiating a price;

FIG. 8 is a photograph of a screen illustrating details for a computer-based system for negotiating a price;

FIG. 9 is a photograph of a screen illustrating an initial offer for a computer-based system for negotiating a price;

FIG. 10 is a photograph of a screen illustrating a negotiation sequence for a computer-based system for negotiating a price;

FIG. 11 is a photograph of a screen illustrating cart items for a computer-based system for negotiating a price;

FIG. 12 is a photograph of a screen illustrating featured items for a computer-based system for negotiating a price;

FIG. 13 is an example illustration system sequence diagram;

FIG. 14 is an example block diagram of a portal application for a computer-based system for negotiating a price;

FIG. 15 is an example block diagram of location services for a computer-based system for negotiating a price;

FIG. 16 is an example block diagram of retailer-server interaction with for a portal for a computer-based system for negotiating a price;

FIG. 17 is an example block diagram of retailer-server interaction with for a computer-based system for negotiating a price; and,

FIG. 18 is an example a block diagram illustrating operation of a computer-based system for negotiating a price.

### DETAILED DESCRIPTION

It is understood that this disclosure is not limited to the particular methodology, materials, and modifications described and as such may, of course, vary. It is also understood that the terminology used herein is for the purpose of describing particular aspects only and is not intended to limit the scope of the present disclosure.

Unless defined otherwise, all technical and scientific terms used herein have the same meaning as commonly understood to one of ordinary skill in the art to which this disclosure belongs. It should be understood that any methods, devices, or materials similar or equivalent to those described herein can be used in the practice or testing of the disclosure. Moreover, although any methods, devices, or materials similar or equivalent to those described herein can be used in the practice or testing of these embodiments, some embodiments of methods, devices, and materials are now described.

The following non-limiting definitions are applicable to the present invention:
Wireless Communications Device (WCD): A communications device that transceives via a non-wired medium, such as radio frequency. A WCD can include, but is not limited to an AM or FM radio device, a television, cell phones, smart phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, 3G and 4G. Electronic Ink referenced herein shall refer to an electrophoretic display that reflects light like ordinary paper.
Network address: A universal resource locator (URL) or an Internet Protocol address (IP Address). All requests for service or information are formatted using a standard data encoding protocol such as XML. A secure transfer protocol such as HTTPS is used when necessary to ensure data security.

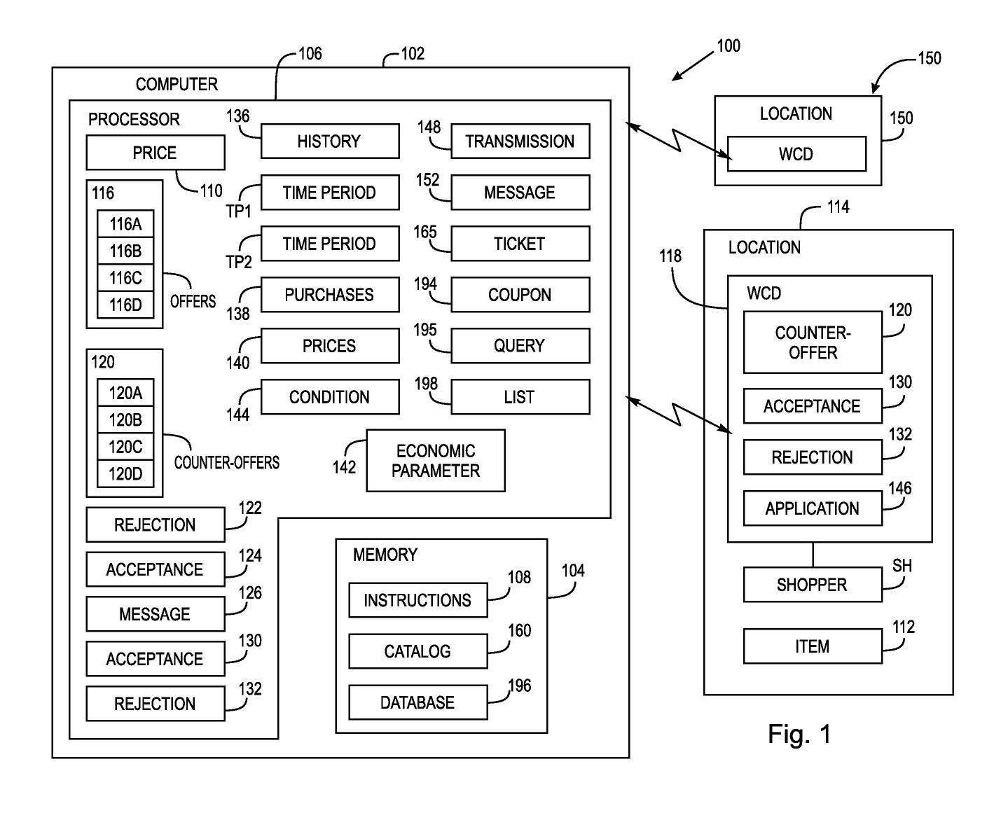

FIG. 1 is a schematic block diagram of computer-based system 100 for negotiating a price.

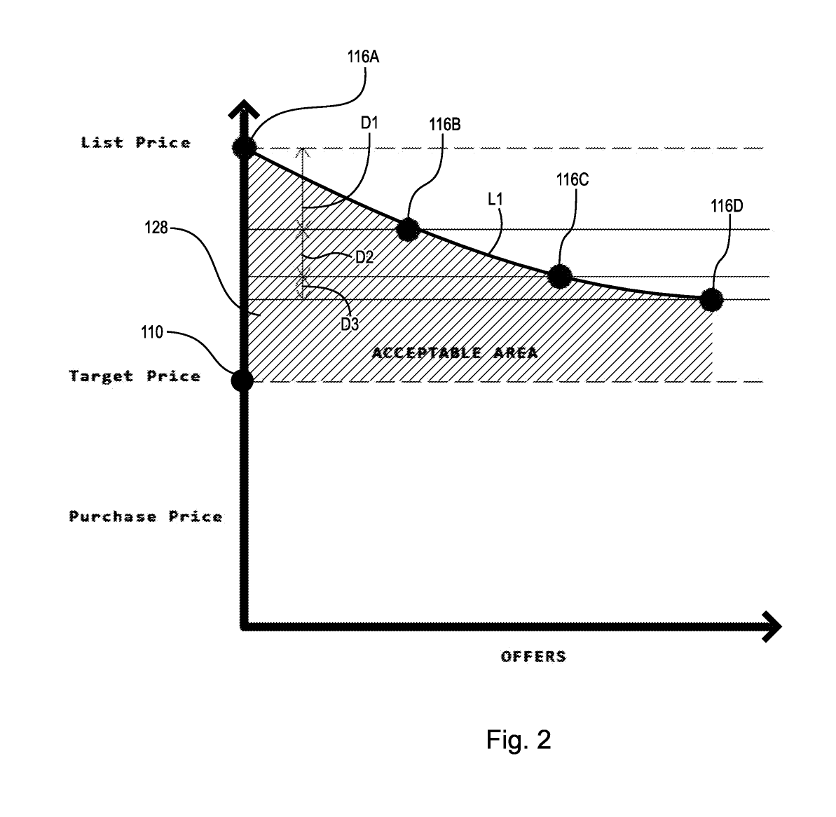

FIG. 2 is an illustration of an example negotiation strategy for system 100 shown in FIG. 1. The following should be viewed in light of FIGS. 1 and 2. System 100 includes at least one computer 102 with at least one memory element 104 and at least one processor 106. The memory element is configured to store computer readable instructions 108. The processor is configured to execute the computer readable instructions to generate target price 110 for item 112 available for purchase at retail sales location 114. The processor is configured to execute the computer readable instructions to generate a plurality of offers 116 greater than the target price and implement at least one iteration of a sequence including transmitting respective offer 116 from the plurality of offers, receiving from a wireless communications device (WCD) 118 in the retail sales location, respective counter-offer 120 less than respective offer 116, and transmit for receipt by WCD 118 one of rejection 122 of the respective counter-offer, acceptance 124 of the respective counter-offer, or message 126 that a negotiation for item 112 is terminated. WCD 118 is assumed to be under the control of shopper SH. It should be understood that in general, actions described above and below and attributed to system 100 or the processor are a consequence of the processor executing the computer readable instructions to implement the action in question.

FIG. 2 illustrates an example negotiation strategy, including the target price and offers noted above, that provides useful pricing signals but advantageously does not reveal target price 110. The y axis in FIG. 2 represents prices per unit of item 112 and the x axis is offers 116. The goals of the negotiation strategy include increasing sales and preventing competitors and shoppers from relying on published prices alone for comparison shopping. For example, a price negotiable for item 112 is not published before hand and cannot be predicted. Specifically, the negotiated price depends on the target price and offers, which are not known to a competitor or shopper.

FIG. 2 illustrates mechanics of the negotiation strategy. A series of predetermined pricing signals (offers 116A-116D) are computed by system 100 as further described below. The relative magnitude of each offer diminishes as the offers approach the target price. In an example embodiment, a shopper specifies the number of units that are to be negotiated for. In an example embodiment, when the number of units is greater than one, all offers and counter-offers are scalar multiples of the quantity specified.

The sequence noted above is explained in further detail below. However, the following are examples of possible iterations of the sequence. An initial offer 116A, for example, the list price for the item (the price at which the item is available without using system 100) is transmitted, an initial counter-offer 120A is received from WCD 118 in response to offer 116A and the system has the choice of the three options noted above. Counter-offer 120A is not in acceptable range 128 defined as the area above the target price and under line L1. However, since offer 116A is an initial offer, the system transmits rejection 122 and another lower offer 116B. Counter-offer 120B, less than offer 116A, but more than counter-offer 120A is received from WCD 118. Counter-offer 120B is still not in the acceptable range. Again, the system has the choice of the three options noted above.

To keep the negotiation active, the system transmits rejection 122 and offer 116C lower than offer 116B but greater than counter-offer 120B. Counter-offer 120C, less than offer 116B, but more than counter-offer 120B is received from WCD 118. Counter-offer 120C is still not in the acceptable range. Again, the system has the choice of the three options noted above. To keep the negotiation active, the system transmits rejection 122 and final offer 116D lower than offer 116C but greater than counter-offer 120C. In an example embodiment, final offer 116D includes a message informing the shopper that the offer is a final offer. Counter-offer 120D is then received from WCD 118. If counter-offer 120D is in the acceptable range, the system transmits acceptance 124 for receipt by WCD 118 and the shopper can redeem item(s) 112 at the price in counter-offer 120D. If counter-offer 120D is still not in the acceptable range, the system transmit message 126 terminating the negotiation. Although four iterations of the sequence are discussed above, it should be understood that any number of iterations are possible and that system 100 is not limited to any particular number of iterations.

Thus, after transmission of offer 116A, the shopper is reacting to offers 116 (price signals) calculated and generated by system 100 beforehand. Until the transmission of the final offer, the shopper has three choices upon receipt of an offer 116: transmit, via WCD 118, acceptance 130 of the offer for receipt by system 100, transmit, via WCD 118, rejection 132 ending negotiation for receipt by system 100, or transmit, via WCD 118, a counter-offer for receipt by system 100. If a counter-offer is greater than or equal to target price system 100 immediately accepts the counter-offer, places item 112 into a virtual cart for the shopper, and transmits acceptance 124. When the final offer is transmitted, the shopper has only two choices accept or reject the final offer. To accept the offer, acceptance 130 of the offer is transmitted by WCD 118 for receipt by system 100. System 100 places item 112 into the shopper's virtual cart and transmits acceptance 124. If the final offer is rejected, system 100 transmits message 126 and the list price of the item is used should the shopper decide to purchase item 112 at the retail location without using system 100.

In an example embodiment, a difference between successive offers 116 in the sequence diminish. That is, a difference between a respective offer 116 in a current iteration and the respective offer 116 in an immediately preceding iteration decreases. For example, as shown in FIG. 2, D3 is less than D2, which is less than D1.

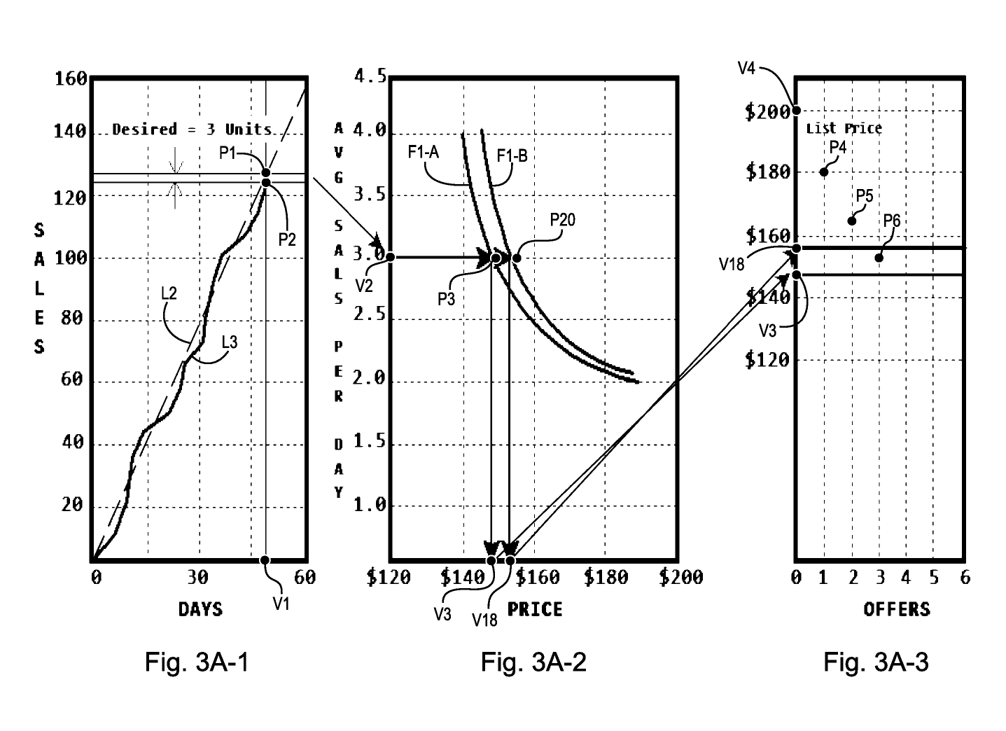

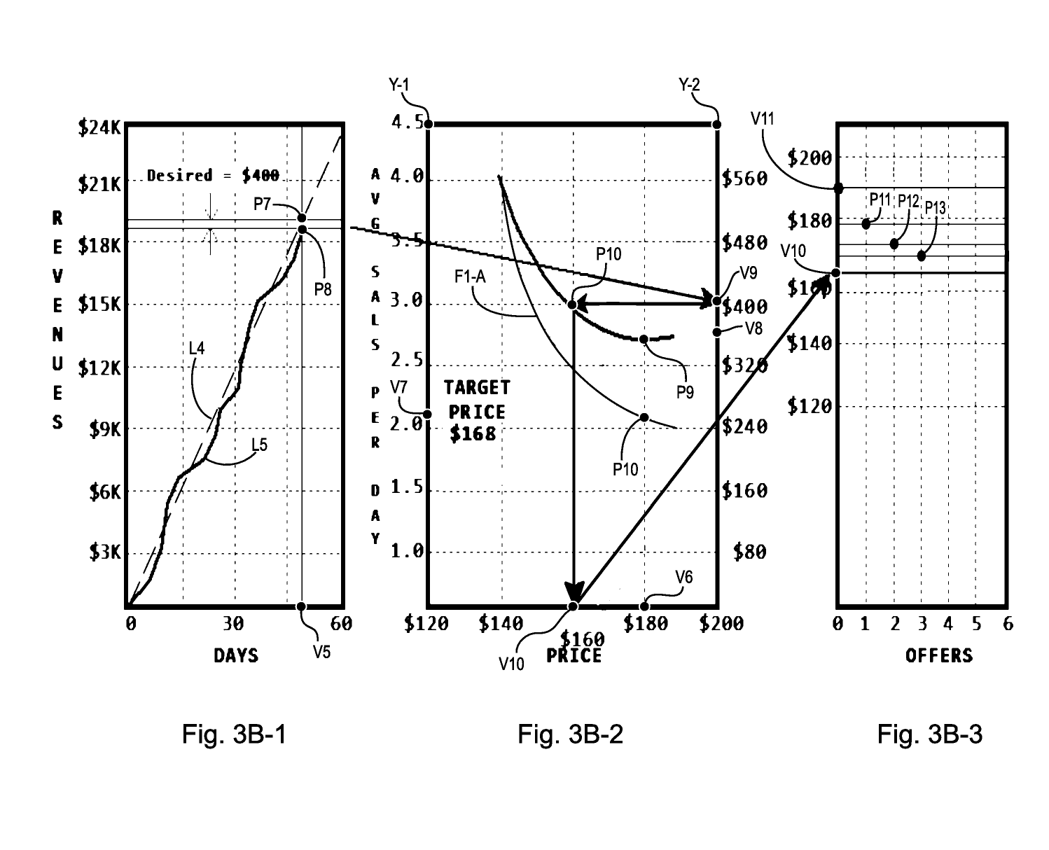

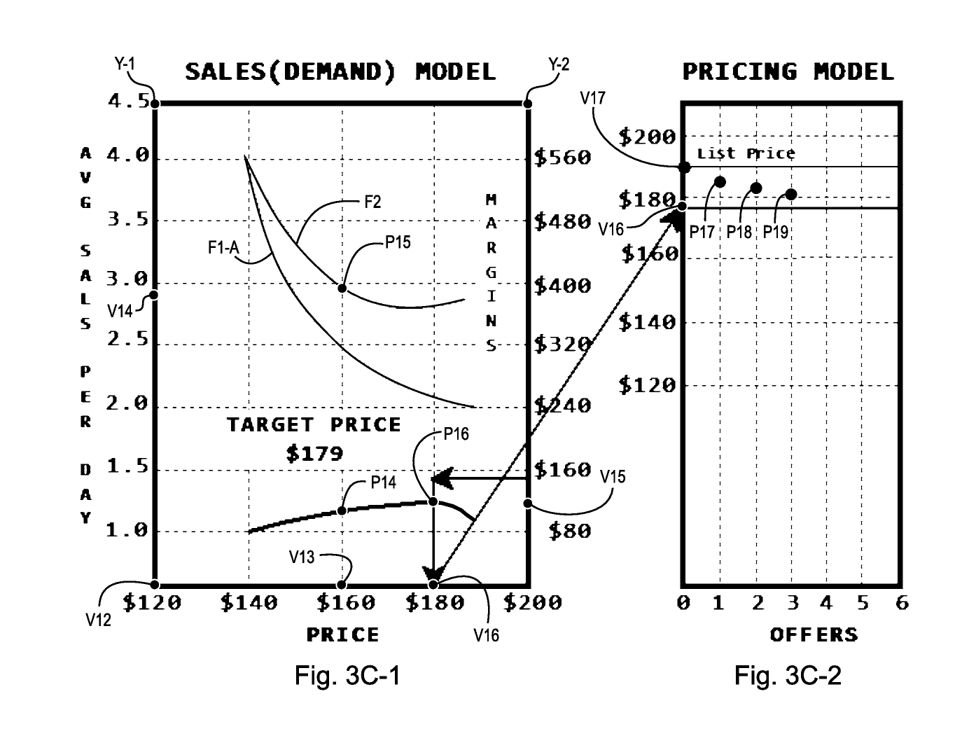

FIGS. 3A through 3C are respective example illustration of respective economic basis for target price selections. The following should be viewed in light of FIGS. 1 through 3C. In an example embodiment, system 100 uses dynamic feedback, based on previous transactions, to select, generate, or modify the target price and offers 116. The processor generates sales history 136 for item 112, over a time period TP1. The history includes purchases 138 of item 112 based on respective accepted counter-offers (that is, items 112 purchased through system 100) and a respective price 140 for each purchase. The processor selects the target price using to the sales history, for example, as further described below. The processor accepts respective selections of economic parameter 142 and condition 144 of the economic parameter. The processor determines a price 140, using the sales history, satisfying the condition of the economic parameter and selects the price as the target price.

In FIG. 3A, the economic parameter is sale of a specified number of units of item 112 over time period TP1, in this case, 160 units in 60 days at maximum profit. Note that profit can be represented by the area under the curve for function F1 described below. Graph 3A-1 illustrates the goal and is an example of determining whether the parameter is being satisfied. In graph 3A-1, the y axis is total units sold and the x axis is time units, in this case days. Line L2 identifies a linear implementation of satisfying the economic parameter of selling 160 units in 60 days. That is, L2 assumes a same average number of sales per day. Line L3 identifies actual sales. Value V1 on the x axis represents a current day in which adjustment of the target price is desired. Point P1 on line L2 is the desired sales level, and point P2 on line L3 is the actual sales. The difference along the y axis is the target number of units needed to satisfy the condition of the economic parameter.

In an example embodiment, actual sales trends according to the day of the week are factored into L2 and L2 is non-linear. For example, a total of 21 sales is the goal for a week (an average of three per day); however, the goal for Monday and Tuesday could be 1 sale per day and the goal for Friday and Saturday could be 5 sales per day, based on typical sales for those days. In this case, L2 includes curves reflecting the varying per-day sales goals.

To determine the desired target price to satisfy the condition of the economic parameter, the processor generates graph 3A-2, which shows function F1 based on the sales history. The y axis represents the number of units of item 112 sold per time period TP2, for example, one day, during the span of the sales history and the x axis represents price 140 per unit of item 112 sold. Value V2 on the y axis is selected as equal to the difference from graph 3A-1. Point P3 on F1-A corresponds to V2. Using P3, value V3 on the x axis is identified as price 140 satisfying the condition of the economic parameter. Value V3 is then transferred to graph 3A-3 in which the y axis represents a per-unit price for unit 112 and the x axis represents offers 116. On the y axis, value V3 is the selected value for the target price, V4 is the list price (116A) for item 112, and points P4-P6 are offers 116B-116D, respectively. Stated otherwise, the processor generates function F1 including a first, X, variable representing respective prices paid per unit of the first item and a second, Y variable representing respective numbers of units of item 112 sold per time period TP2.

In FIG. 3B, the economic parameter is revenue from sale of item 112 over time period TP1, in this case, $24,000 in 60 days at maximum profit. Graph 3B-1 is an example of determining whether the parameter is being satisfied. In graph 3B-1, the y axis is revenue from sale of item 112 and the x axis is time units, in this case days. Line L4 identifies a linear implementation of satisfying the economic parameter of $24,000 in revenue in 60 days. Line L4 identifies actual revenue. Value V5 on the x axis represents a current day in which adjustment of the target price is desired. Point P7 on line L4 is the desired revenue level, and point P8 on line L5 is the actual revenue. The difference along the y axis, in this example, $400, is the target revenue needed to satisfy the condition of the economic parameter. The discussion for graph 3A-1 regarding non-linearity is applicable to graph 3B-1.

To determine the desired target price to satisfy the condition of the economic parameter, the processor generates graph 3B-2, which shows function F1-A and function F2 derived from function F1-A. Axis Y-1 represents the number of units of item 112 sold per time period TP2 (in this case per day) and the x axis represents price 140 per unit of item 112. Axis Y-2 represents revenue associated with sales of item 112. F2 represents revenue per respective values on the x axis. As an example of how F2 is generated, to generate point P9 on F2 for value V6 on the x axis, the processor multiples value V6 by value V7 on Y-1. V7 is the value on Y-1 for point P10 on F1-A. The result of the multiplication is value V8 on Y-2.

Value V9 on Y-2 is equal to the difference of $400 from graph 3B-1. Point P10 on F2 corresponds to V9. Using P10, value V10 on the x axis is identified as price 140 satisfying the condition of the economic parameter. Value V10 is then transferred to graph 3B-3 in which the y axis represents a per-unit price for unit 112 and the x axis represents offers 116. On the y axis, value V10 is the selected target price, V11 is the list price (116A) for item 112, and points P11-P13 are offers 116B-116D, respectively. Stated otherwise, the processor generates function F2 including a first, X, variable representing respective prices paid per unit of the first item and a second, Y variable representing respective revenues generated per value of the first variable,

In FIG. 3C, the economic parameter is profit level from sale of item 112 over time period TP1, in this case, maximizing profit over the 60 day span. To determine the desired target price to satisfy the condition of the economic parameter, the processor generates graph 3C-1, with function F3 plotting profit. Function F3 is derived using function F2. Axis Y-1 represents the number of units of item 112 sold per time period TP2 (in this case per day) and the x axis represents price 140 per unit of item 112. Axis Y-2 represents profit associated with sale of item 112 at respective prices. Value V12 on the x axis is the price paid for item 112 by the retail business selling item 112. As an example of generating function F3, point P14 on F3, corresponding value V13 on the x axis is generated by selecting point P15 on F2, associated with V13 and selecting value V14 on Y-1. The revenue is then found my multiplying V13 by V14 (number of units x price per unit). The profit will be the remainder when the cost to the retailer, represented by a multiple of V12, is subtracted from the revenue. In this case, the cost to the retailer is V12 multiplied by V14 (number of units x cost to retailer per unit).

Point P16 on F3 is the maximum value on Y-2 and satisfies the condition of the economic parameter. The profit/remainder is value V15 on Y-2 associated with point P16 on F3. Using P16, value V16 on the x axis is identified as the target price. Value V16 is then transferred to graph 3C-2 in which the y axis represents a per-unit price for unit 112 and the x axis represents offers 116. On the y axis, value V16 is the selected target price, V17 is the list price (116A) for item 112, and points P17-P19 are offers 116B-116D, respectively. Stated otherwise, the processor generates function F3 including a first, X, variable representing respective prices paid per unit of the first item and a second, Y variable representing respective profits generated per value of the first variable.

In an example embodiment, the economic parameter goal, for example, graphs 3A-1 and 3B-1 are updated according to time period TP2, for example, daily. Within a time period TP2, targets for the respective economic parameters are not modified regardless of any sales of item 112 within that time period TP2. For example, at the start of a day, values V2 and V7 are selected and these values remain constant for the duration of the day. Values V2 and V7 may be modified for the following day according to sales activity during the previous day.

In an example embodiment, functions F1, F2 and F3 are updated for every sale of item 112. For example, returning to graph 3A-2, function F1-A results from a first sale of a unit of item 112 in time period TP2. Then, when a second sale is made, F1-A is updated to generate F1-B. Point P20 on F1-B is associated with V2, which results in V18 on the x axis being selected as the updated target price, which is transferred to graph 3A-3. Points P4-P6 are adjusted accordingly. For the sake of clarity, these adjustments are not shown on graph 3A-3. In like manner, as F2 and F3 are updated for each sale of item 112, the respective target prices (V10 and V16 for example) are updated.

In an example embodiment, application 146 is stored on WCD 118 and the processor receives transmission 148 from the WCD to initiate interaction with system 100 as further described below. The processor confirms that WCD 118 is in retail location 114, for example, using known global positioning system (GPS) technology, before implementing the operations noted above and below. If a WCD communicating with system 100 is not in a retail location utilizing system 100, system 100 does not implement the operations noted above with the WCD. This precaution prevents shoppers and competitors from remotely manipulating system 100 for the purpose of identifying, analyzing, or predicting target prices.

In an example embodiment, application 146 is stored on WCD 118 and the processor receives transmission 148 from the WCD to initiate interaction with system 100 as further described below, while the WCD is in retail sales location 150. The processor determines if system 100 is in use in location 150. If system 100 is not in use in location 150, the processor transmits message 152 for receipt by an entity owning or operating location 150. The message states that a request was made to implement the sequence at retail sales location 150. In this manner, business entities not using system 100 can be made aware of a desire by the buying public to use system 100, which may increase usage of system 100 in the market place.

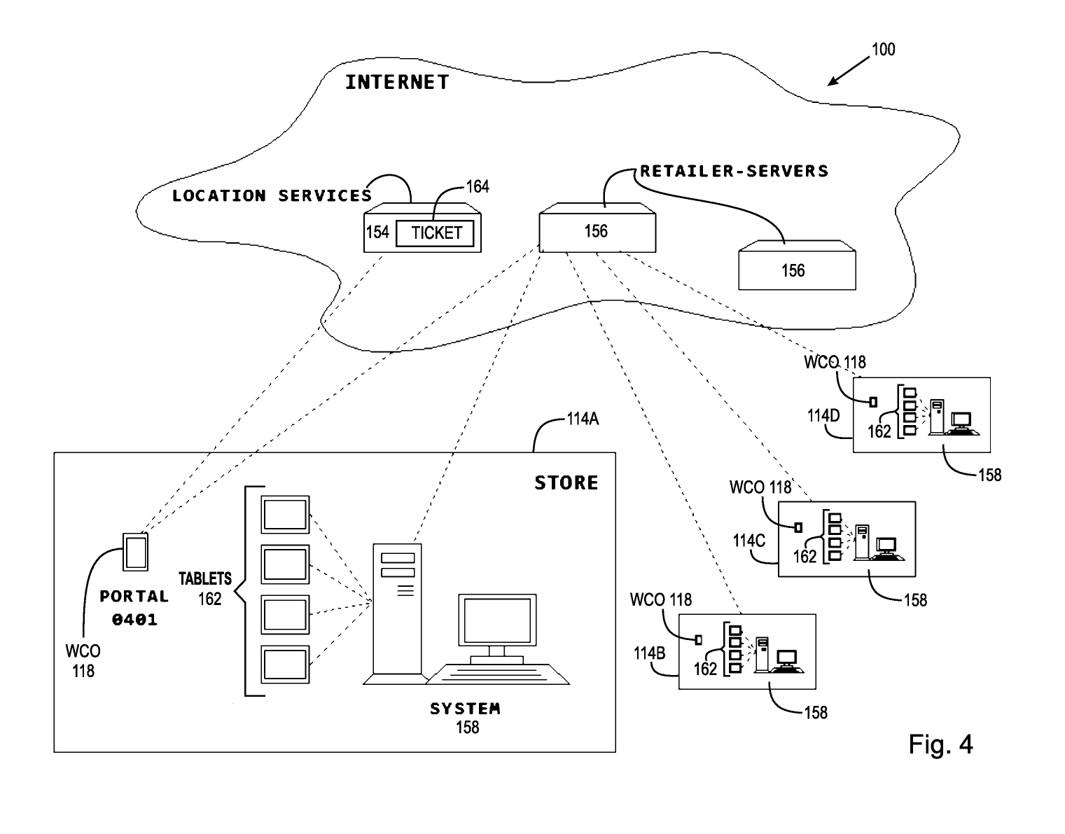

FIG. 4 is an illustration of example distributed computer-based system 100 for negotiating a price. In an example embodiment, system 100 is in the form of a distributed computing network consisting of multiple autonomous components that communicate through the Internet. The individual components include a portal application, for example, application 146 stored in a WCD such as WCD 118; Internet hosted location service 154; one or more Internet hosted retailer-servers 156; and computer-based system 158 at each participating retail sales location, for example, locations 114A-114D. Optionally one or more point-of-sale electronic ink tablets 160, configured to interface with respective systems 158 are available for use by respective shoppers at respective locations 114. In an example embodiment, a distributed computer-based system 100 does not include service 154 and server 156. In this case, a WCD directly connects to system 158 via application 146. It should be understood that the servers and computers shown in FIG. 4 collectively can be considered the at least one computer 102 of FIG. 1.

Application 146 runs from a WCD to provide the shopper with access to the distributed network. In an example embodiment, application 146 first connects to service 154 to identify a participating location. Once identified, the location is confirmed and application 146 posts subsequent requests to server 156 assigned to the current location. System 158 for the location manages item catalog 160 (items available for purchase via system 100), maintains respective target prices and offers, and optionally operates tablets 162 used to display coupons, for example, visible to red-laser scanners.

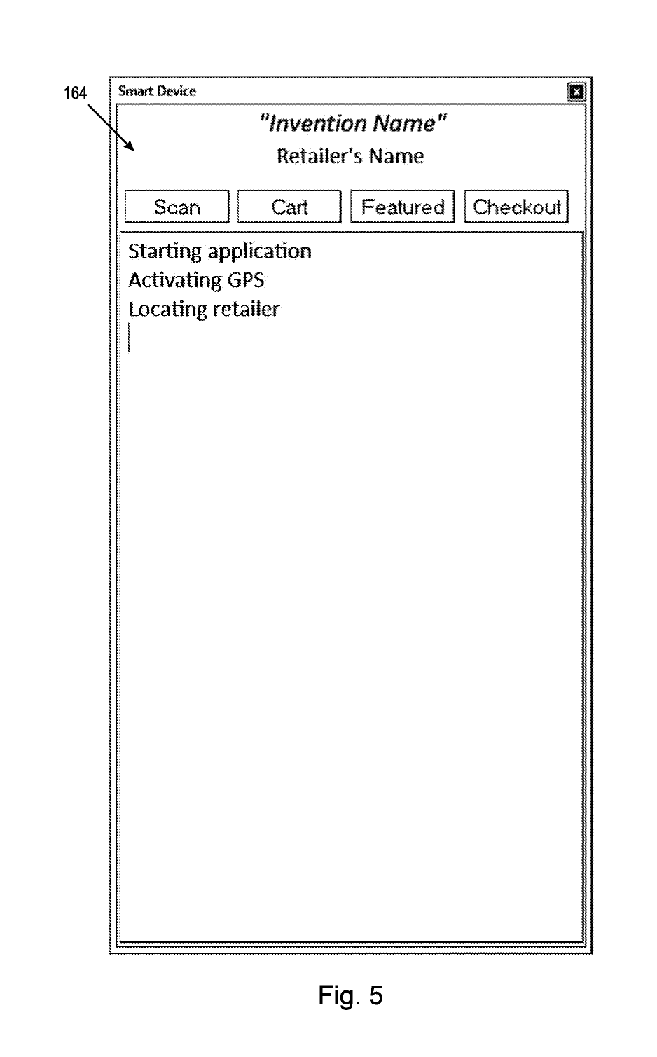

FIGS. 5 through 12 are respective photographs of screen illustrating example implementation of system 100. FIG. 5 is a photograph of a screen illustrating start menu 164 for a computer-based system for negotiating a price. Hereinafter, the terms “store” and “retail location” are used interchangeably. It is a requirement that a shopper be physically present in a participating location to prevent competitors and online shoppers from discovering the nature of target prices for the location. In an example embodiment, a shopper starts application 146 on a WCD at a particular retail location and utilizes an on-board GPS and a hosted service 154. The GPS obtains the current location and posts the current location and data identifying the WCD to the hosted service 154. The hosted service 154 determines the identity of the location based upon its longitude and latitude. If a participating retail sales location is found at the submitted location, the hosted service 154 returns globally unique ticket ID 165 and the network address of a hosted server 156 assigned to that location.

If there are several participating locations in the vicinity; service 154 returns a list of locations sorted by distance from the submitted retail location. If there are no participating retail locations nearby, the shopper is informed and the submitted retail location is stored and counted as a non-participating retail location. In an example embodiment, once the number of requests for a non-participating retail location reaches a specified threshold, a business entity operating or owning the retail location is contacted and informed of the number of shoppers who wish to use system 100.

Inside location 114 the shopper uses application 146 to identify and then negotiate a lower price on items specified by the location. A retail location makes items available by uploading catalog 160 to a hosted server 156 using system 158. Each catalog entry includes, but is not limited to: the item's name, the manufacturer's name, a photographic image, and a brief description. Additionally, system 158 uploads target prices and offers upon demand or whenever the outcomes of current target prices deviate too much from a desired goal, for example, satisfying conditions 144. The discussion for FIGS. 3A through 3C is applicable the deviation and adjustments made in response to the deviation.

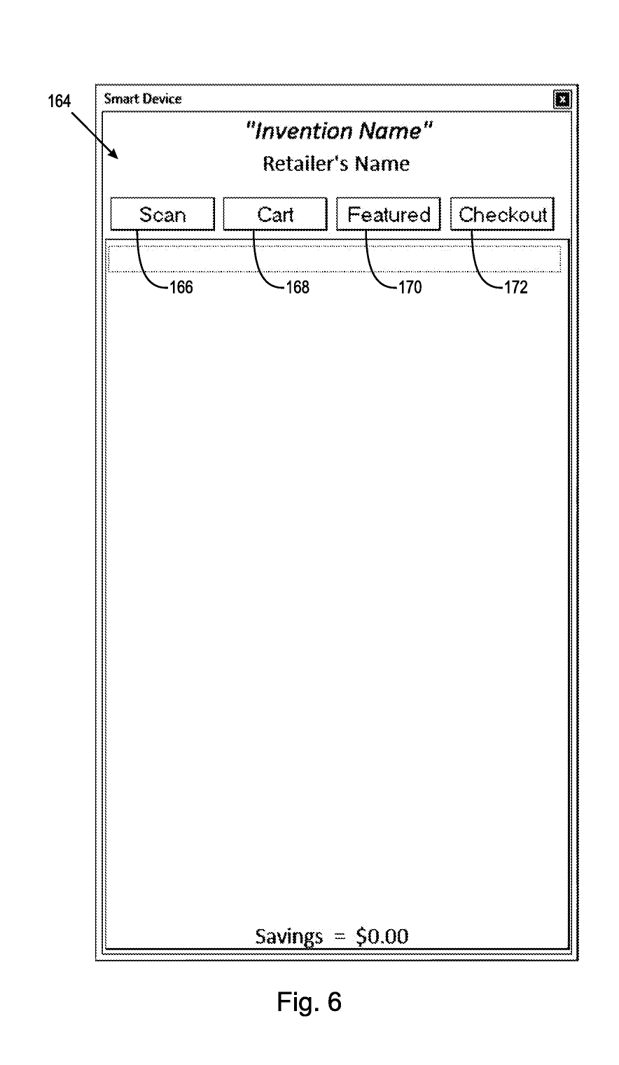

FIG. 6 is a photograph of a screen illustrating main menu 164 for a computer-based system for negotiating a price. In an example embodiment, menu 164 includes buttons/functions SCAN 166, CART 168, FEATURED 170, and CHECKOUT 172.

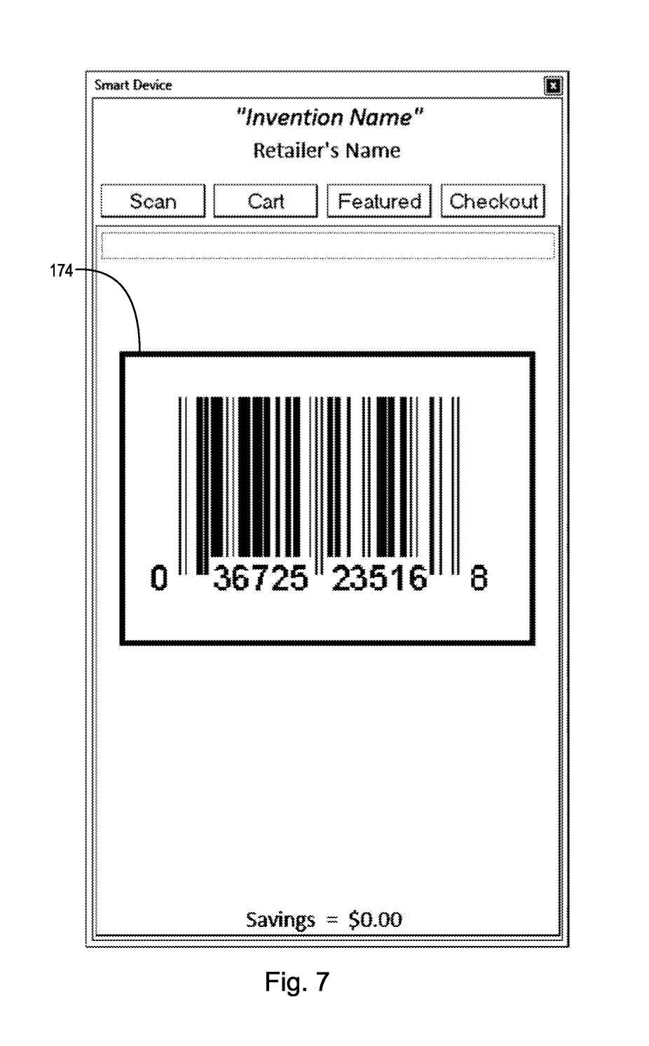

FIG. 7 is a photograph of a screen illustrating a scan for a computer-based system for negotiating a price. To generate FIG. 7, a shopper activates the SCAN function in FIG. 6 to determine if an item is available for negotiation. In an example embodiment, on-board camera for the WCD is used to photograph the item's barcode and convert the barcode into series of alphanumeric characters 174 If the item is not available for negotiation, the shopper is informed and continues shopping.

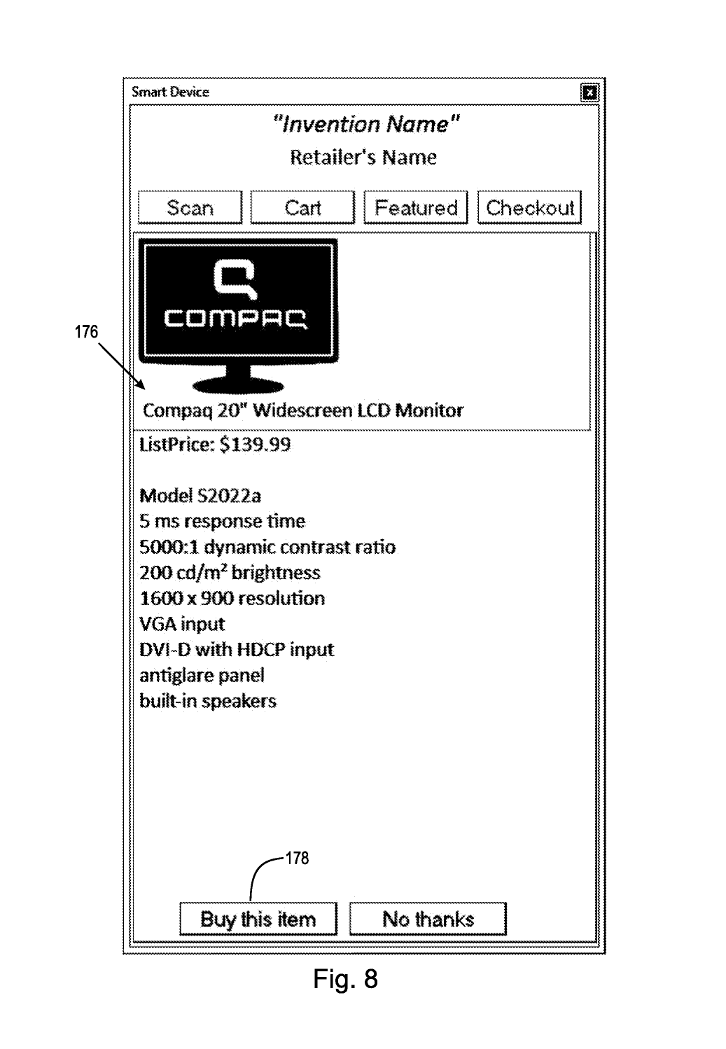

FIG. 8 is a photograph of a screen illustrating details for a computer-based system for negotiating a price. FIG. 8 is generated in response to the barcode of FIG. 7. If the item is available through system 100, detailed information 176 from the catalog is sent back to application 146 for display and the shopper is given the choice of negotiating for the item or to continue shopping.

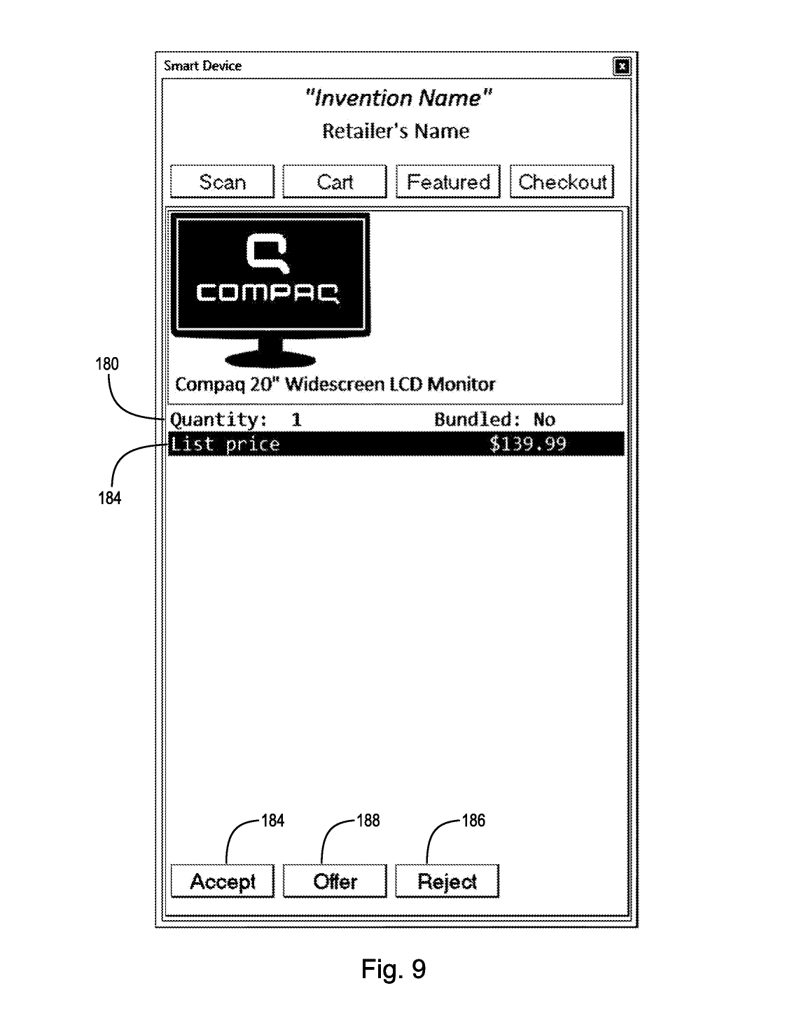

FIG. 9 is a photograph of a screen illustrating an initial offer for a computer-based system for negotiating a price. To generate the screen of FIG. 9, the shopper elects to negotiate a lower price by selecting button 178 in FIG. 8. In field 180, the shopper can select a quantity of items for which to negotiate prices. When the quantity is selected, the store's initial offer, offer 116A for example, is shown in field 182. In the cases where the quantity is greater than one, all offers and counter-offers are scalar multiples of the quantity specified. The screen in FIG. 9 provides the following choices: accept the offer 184, reject the offer 186, or make a counter-offer 188. If the shopper accepts the current offer, the item is placed into their virtual cart and the display changes to list all of the items in the cart. If the shopper rejects the current offer, the display changes to list all of the items in the cart.

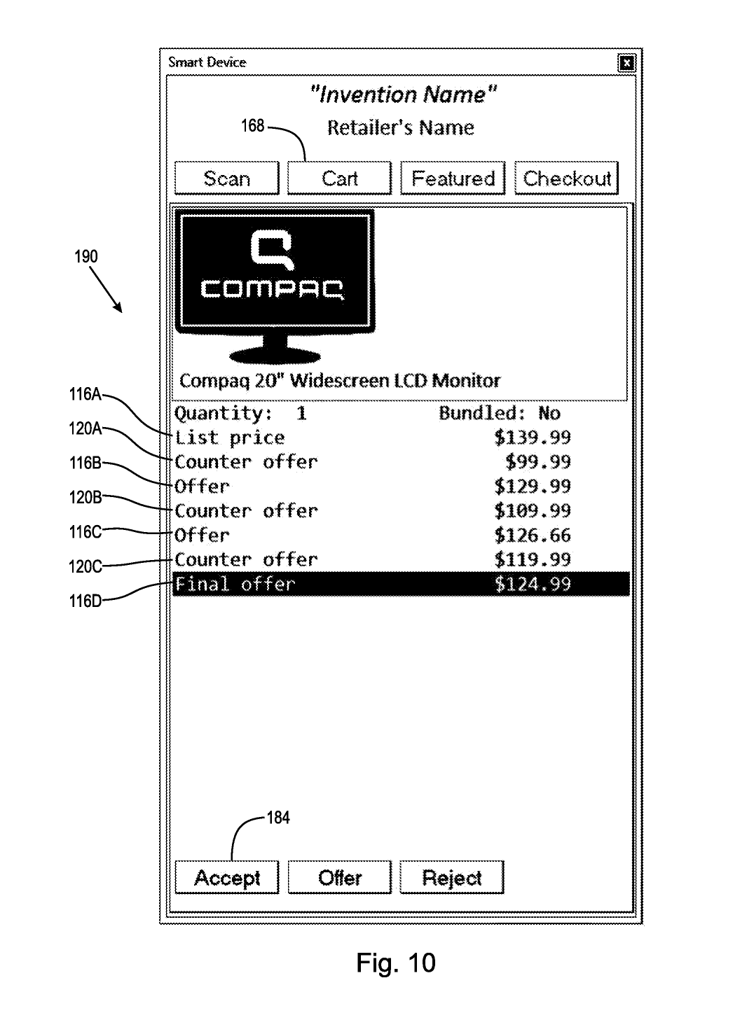

FIG. 10 is a photograph of a screen illustrating a negotiation sequence for a computer-based system for negotiating a price. To generate the screen in FIG. 10, the shopper selected 188 in FIG. 9. Field 190 shows a series of offer and counter-offers. The initial counter-offer is posted to hosted server 156. The hosted server 156 responds with one of two results: the counter-offer is accepted, the item will be placed in the cart, and the display will lists the items in the cart; or the counter-offer was rejected and the server 156 makes another offer until the final offer has been reached as shown in FIG. 10. The negotiation strategy continues until the shopper either accepts or rejects the location's offer.

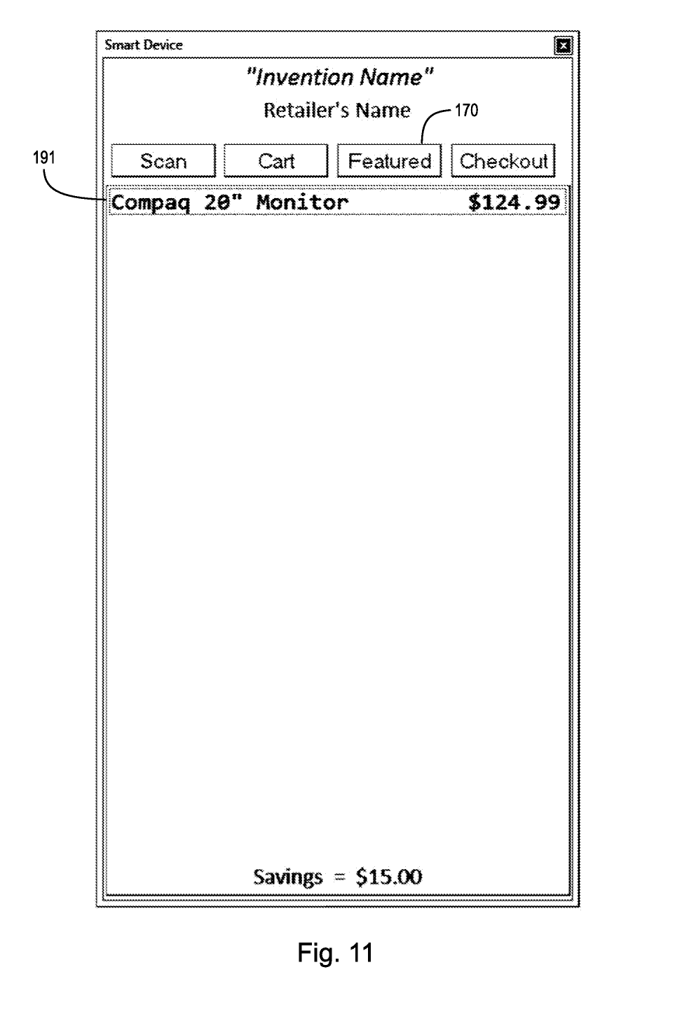

FIG. 11 is a photograph of a screen illustrating cart items for a computer-based system for negotiating a price. To generate the screen of FIG. 11, the shopper selected buttons 184 and 168 in FIG. 10. The CART function lists all of the negotiated items for the current location in field 191. The enumerated list includes the item's name, the model number, the quantity desired, and the negotiated price. Selecting an item from the list opens a display showing the item's details from the catalog.

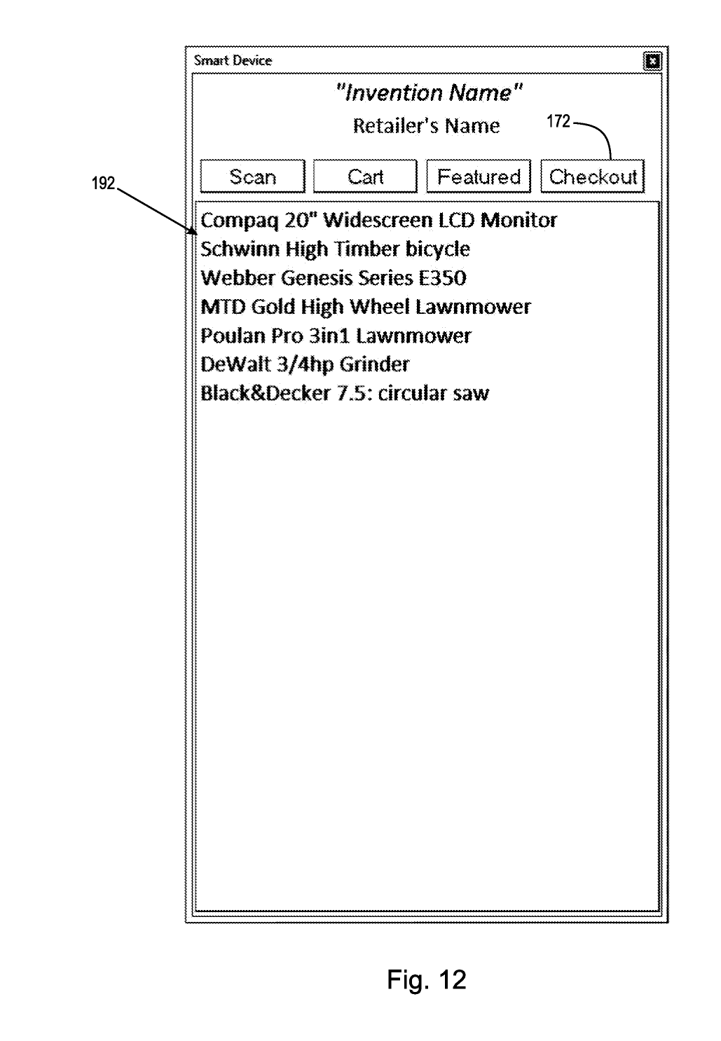

FIG. 12 is a photograph of a screen illustrating featured items for a computer-based system for negotiating a price. To generate the screen of FIG. 12, the shopper selected button 170 in FIG. 11. The FEATURED function lists in field 192 all items that a location desires to bring to the shopper's attention. Selecting an item from the list opens a display showing the item's details from the catalog.

Redemption coupon 194 is generated by system 100, for example, by system 158, for every item 112 for which a negotiated priced as been agreed upon. A shopper activates CHECKOUT function 172 after all of their items have been scanned by a cashier at the location. The CHECKOUT function operates in one of two modes determined by the store. In both cases items 112 are redeemed as coupons 194 generated by system 100 upon demand and optionally posted into a point-of-sale system for the location. In the first case the CHECKOUT function retrieves barcodes for the redemption coupon and displays each respective barcode on the WCD as the coupons are redeemed. In the second case the CHECKOUT function opens a camera scanner and the shopper is required to scan the barcode on tablet 162. Once the scan has been accepted the same redemption barcodes are displayed on the tablet's display. The tablet provides a display that red laser scanners can read.

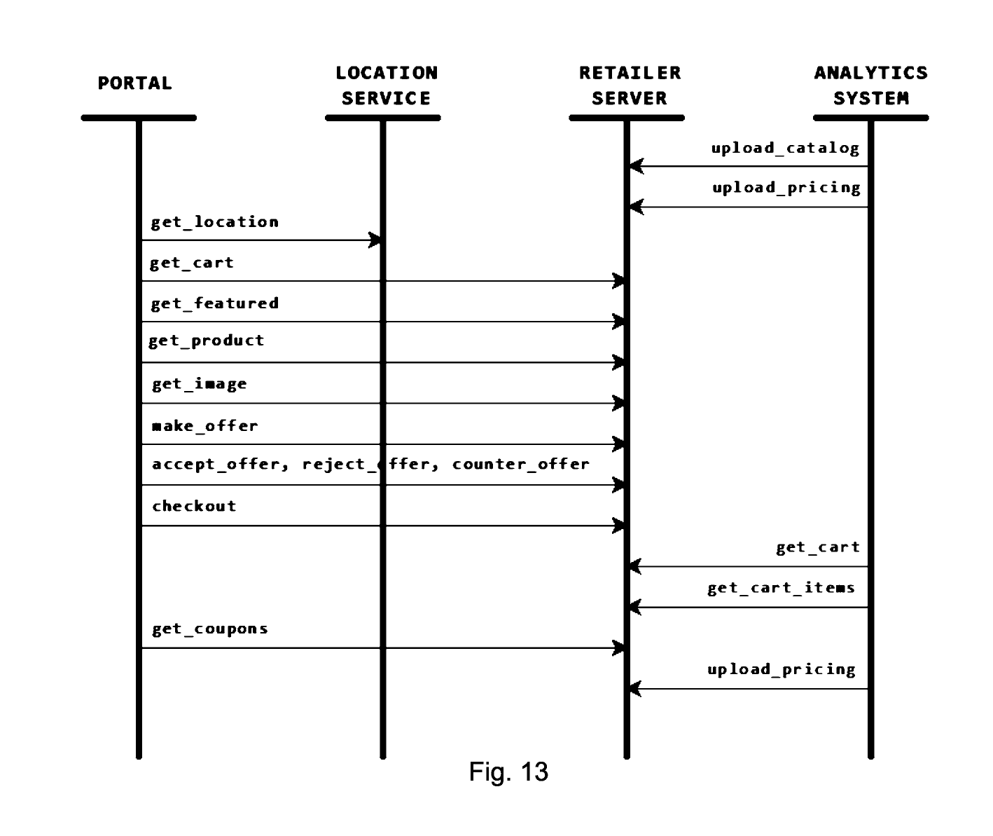

FIG. 13 is an example illustration system sequence diagram. The system sequencing diagram in FIG. 13 illustrates the order of events of an example embodiment of the system. Each component of the system interacts with another in a relative order. These events are described below.

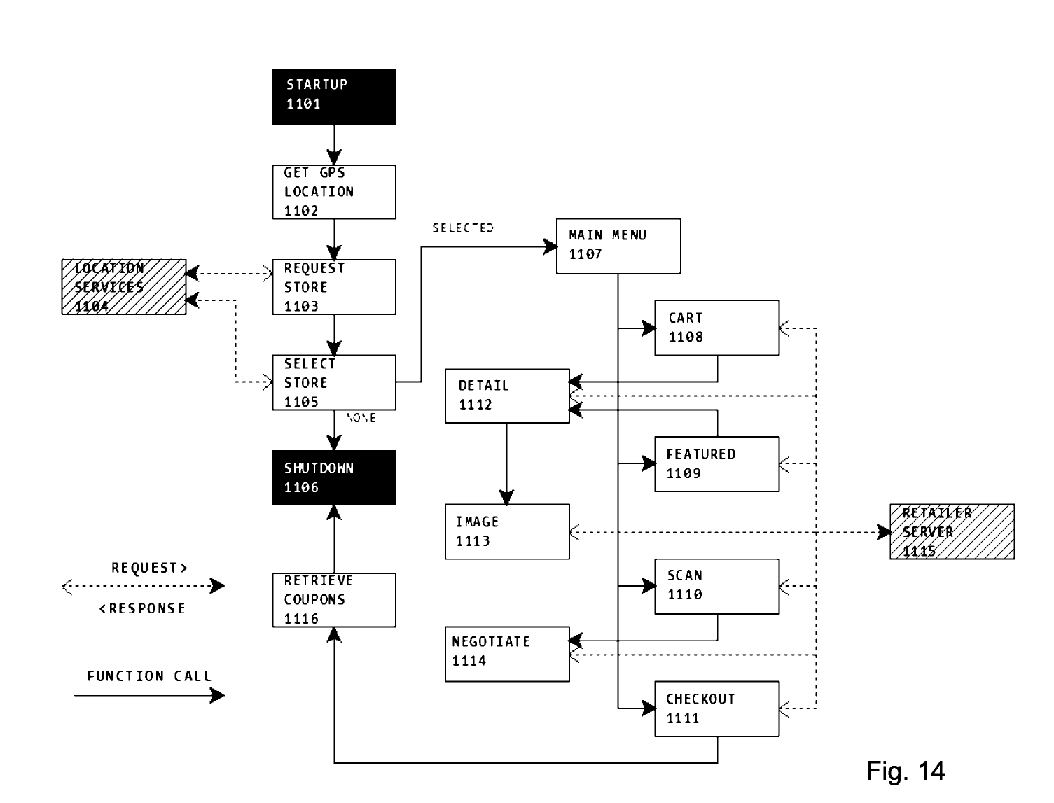

FIG. 14 is an example block diagram of a portal application for a computer-based system for negotiating a price. The block diagram in FIG. 14 is an example illustration of general processes for application 146. The shopper starts application as they enter a retail location (1101). To obtain the local coordinates the application starts the on-board GPS (1102). After receiving data from the GPS, the application sends the current location (latitude and longitude) and the data identifying the WCD to the hosted service 154 using the “get_location” command (1103). The hosted service 154 responds with a list of nearby participating stores and their coordinates. If there are no participating stores the application informs the shopper and shuts down (1106). Otherwise, the shopper may select a store from the list and continue (1105) or shut down the application. When the shopper selects a store, the exact location of the WCD is resent to the hosted service 154 (1104). The hosted service 154 responds with the network address of the assigned hosted server 156 and globally unique ticket ID 165 containing the encoded identity of the shopper and the store.

From main menu 164 (1107), the shopper may view the cart (1108), view the featured item list (1109), scan an item (1110), or checkout and redeem the negotiated savings (1111). Selecting an item from the cart or featured items list displays the item's detailed information (1112) and retrieves the item's image (1113) from the hosted server 156 (1115). When a shopper scans an item, the barcode is sent to the hosted server 156 (1115). If the item is in the catalog, the hosted server 156 returns the item's detailed information along with an image of the item. At this point, an offer to negotiate a price for item 112 is transmitted to the WCD. The negotiation screen from FIG. 9 is displayed and the shopper begins to negotiate for the item (1114) by selecting button 188 for transmission to the hosted server 156 (1115). Each time a shopper accepts an item from the negotiating process the item is added to the cart.

To redeem their savings, the shopper selects CHECKOUT 172 (1111) after all items have been scanned by the store's point-of-sale system. A first checkout mode sends the “checkout” command to the hosted server 156 (1115) and immediately renders redemption coupons on the WCD display, enabling a cashier at location 114 to scan the barcodes into the store's point-of-sale system. A second checkout mode opens a camera scanner and requires the shopper to scan the identification barcode on the display of tablet 162 next to the point-of-sale system. A “checkout” command along with the barcode is sent to the hosted server 156 (1115). The redemption coupons are displayed on the tablet enabling the cashier to scan the coupons into the store's point-of-sale system.

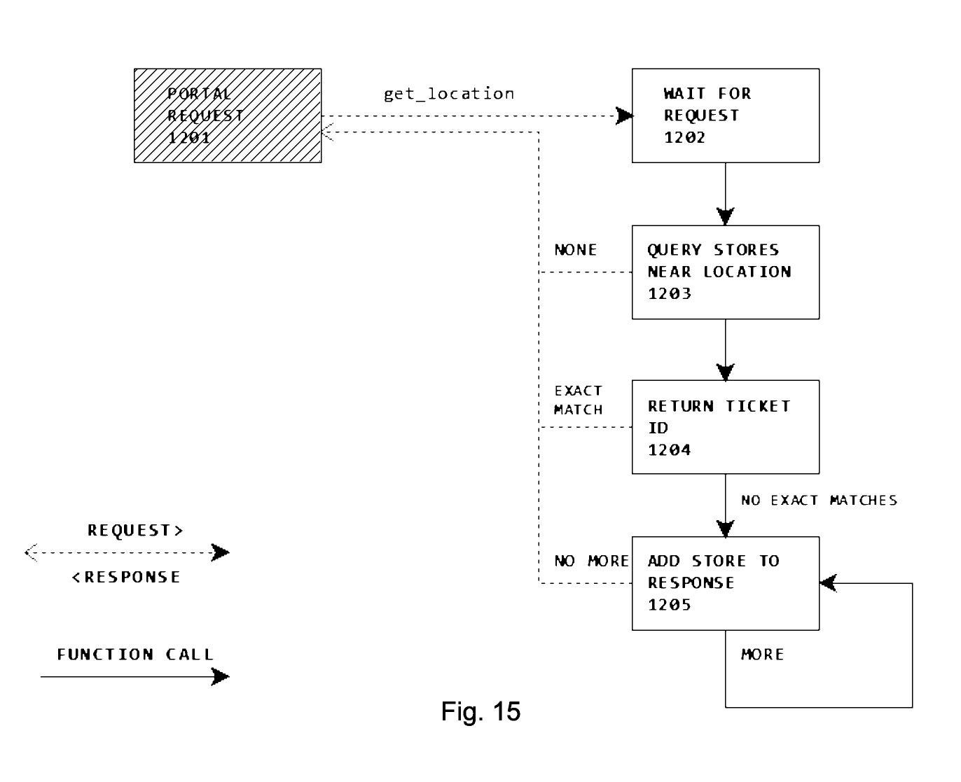

FIG. 15 is an example block diagram of location services for a computer-based system for negotiating a price. The block diagram in FIG. 15 illustrates general processes of an example hosted service 154. Service 154 (1202) responds to incoming requests from application 146 (1201). When the “get_location” command is received, query 195 is run against database 196 looking for participating stores near the coordinates of the shopper (1203). If there are no participating stores nearby, an empty list 198 is returned to application 146 (1201). If there is an exact match to the coordinates, a new globally unique ticket ID 165 is created that encodes the shopper's ID and the retailer's ID (1204). The ticket ID and the network address of the assigned hosted server 156 are sent back to application 146 (1201). The name and coordinates of each participating store are returned by the query and added to list 198 (1205). The resulting list is then returned to application 146 (1201).

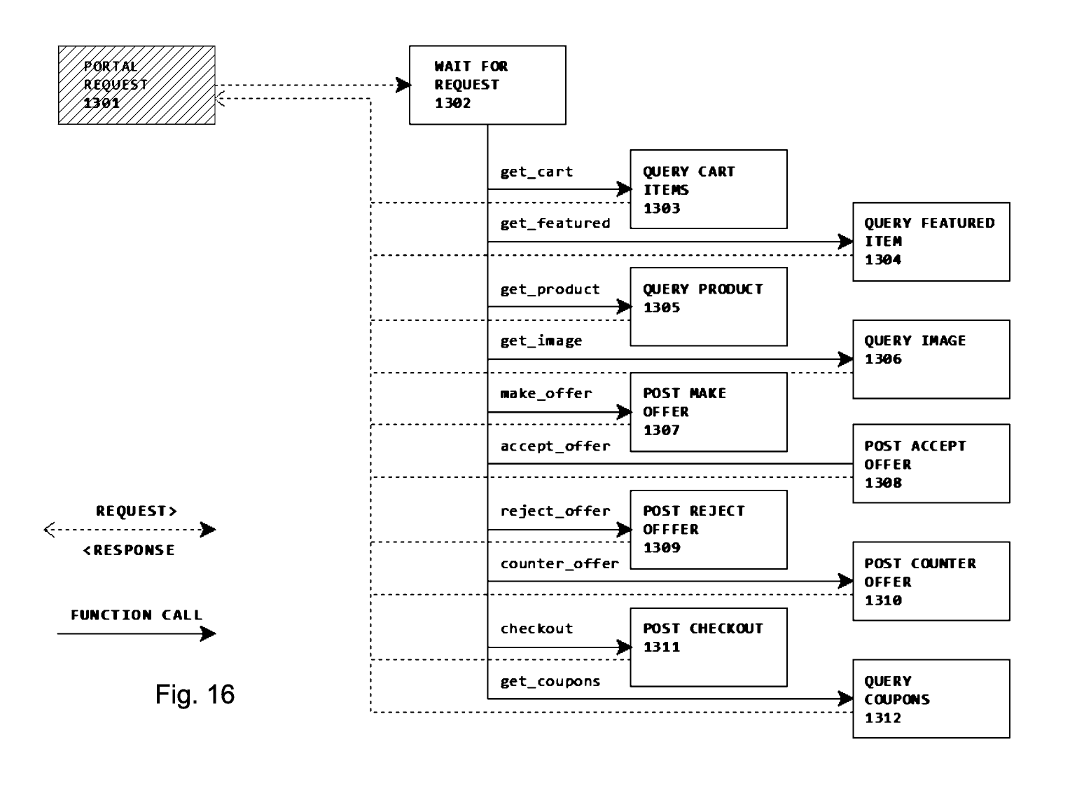

FIG. 16 is an example block diagram of retailer-server interaction with for a portal for a computer-based system for negotiating a price. The block diagram in FIG. 16 illustrates general processes of an example server 156 with application 146. The hosted server 156 waits for incoming requests (1302) from an application 146 (1301). When a shopper selects CART from the main menu, the server 156 queries database 196 for the cart items and returns items in the database to application 146 (1303). When a shopper selects FEATURED from the main menu, the server 156 queries database 196 for the featured items and returns the featured items to the application 146 (1304).

When a shopper scans an item, the barcode is queried against database 196 to locate that item (1305). If the item is present in the database, detailed information and an image for the item are returned to application 146. Application 146 request an item's image whenever a shopper selects an item from the cart or the featured item list (1306). When a shopper elects to negotiate for an item server 156 sends the “make_offer” (button 188) with the item's barcode to open negotiations (1307). As a part of the negotiation process, the shopper may send a command to “accept_offer” (button 184) (1308) placing the item in the cart, “reject_offer” (button 186) (1309) concluding further negotiations on that item, or to make a “counter-offer” (button 188) (1310) which causes the counter-offer to be evaluated. The evaluation results in either acceptance of the counter-offer and placing the item in the cart, sending the next offer 116, or terminating negotiation if the offer was a final offer. When the shopper elects to checkout, the barcode of tablet 162 is posted to database 196 and the cart is marked as “ready-to-checkout.” Under the first checkout mode the resultant coupons are queried from the database and sent back to application 146 (1312).

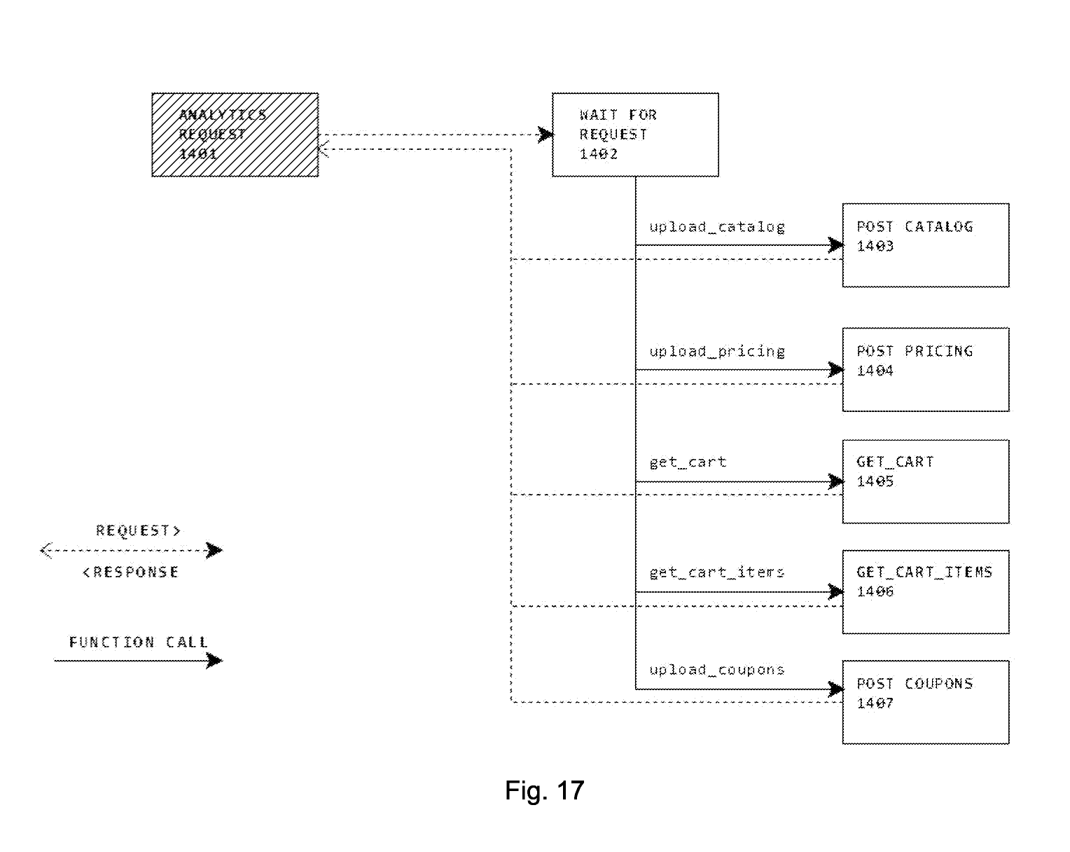

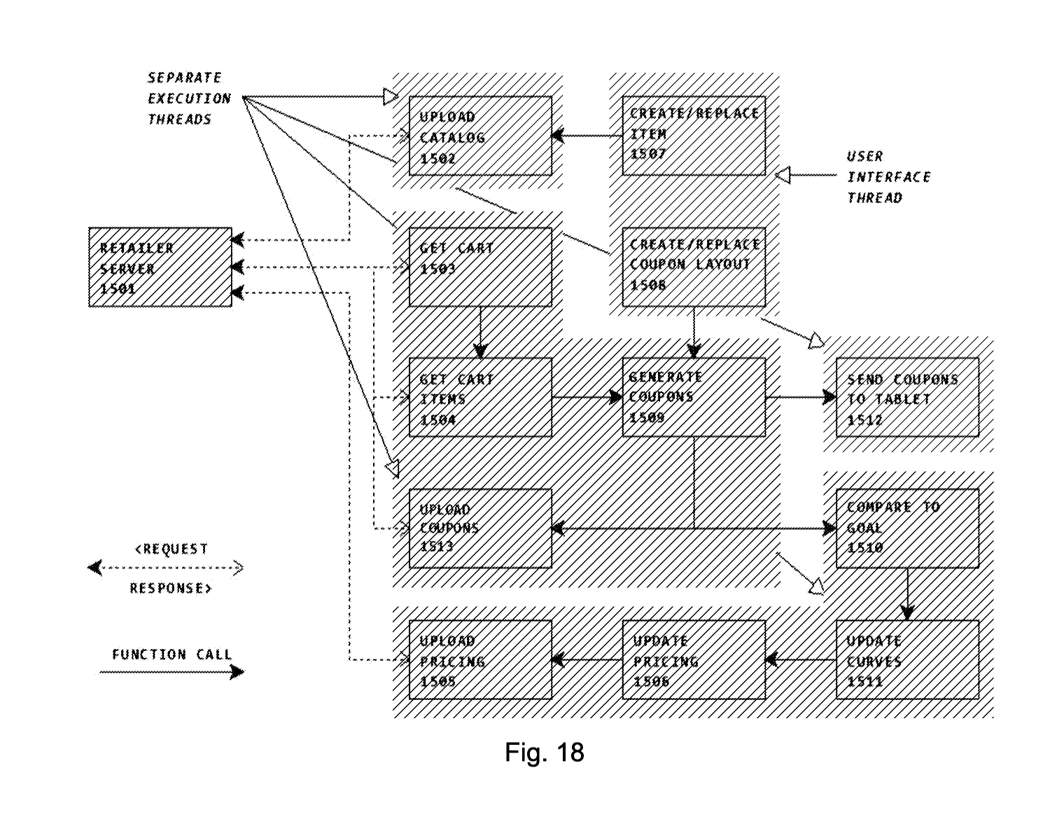

FIG. 17 is an example block diagram of retailer-server interaction with for a computer-based system for negotiating a price. The block diagram of FIG. 18 illustrates general processes of an example server 156 with a store's system 158. The server 156 waits (1402) for requests from the system 158 (1401). The database administration functions of system 158 include uploading catalog 160 (1403) and uploading the pricing data (1404), for example target prices and offers. During normal operation, system 158 polls server 156 looking for carts marked as “ready-to-checkout” (1405). When a cart is ready for checkout, server 156 responds with the cart's information. System 158 responds to a valid cart by requesting to download all of the cart's items (1406). After a cart and its items have been downloaded, system 158 resumes polling for “ready-to-checkout” carts. Under the first checkout mode the coupons for the cart items are uploaded to server 156 (1407).

FIG. 18 is an example a block diagram illustrating operation of a computer-based system for negotiating a price. The block diagram of FIG. 18 illustrates general processes of an example system 158. In one execution thread, system 158 uploads catalog 160 of negotiable items (1502) to its assigned server 156 (1501). In a second execution thread, system 158 queries the hosted server 156 (1501) for the presence of shopping carts marked as “ready-to-checkout” (1503). If there are available carts, the cart's items are downloaded in the same execution thread (1504). If no carts are available, the query is repeated.

After the cart items have been downloaded the items are posted to a third execution thread that generates the proper redemption coupons 194 (1509). Under the first checkout mode, the newly created coupons are uploaded to the hosted server 156 (1513). Under the second checkout mode, the newly created coupons are sent to the appropriate tablet 162 for redemption by the store's point-of-sale system (1512). This third execution thread also examines the goal associated with the sale of an item, for example, satisfying condition 144, to determine if the respective target price is to be updated (1510). If the target price needs to be updated, the demand curve, for example, function F1, is updated (1511), the target price is determined for the appropriate goal, for example as shown in FIGS. 3A through 3C (1506), and the target price uploaded to the hosted server 156 (1505).

Advantageously, system 100 addresses the deficiencies, described above, of fixed “published” pricing and provides additional advantages obtained by using the “beneficial price uncertainty” in inherent in the use of system 100. By “beneficial price uncertainty,” we mean that a price at which an item could be purchased using system 100 is not known ahead of time and cannot be predicted. However, it is certain that the price will be less than the list price for the item. The advantages include:
1. Providing a means by which both a retailer and shopper benefit from closing a sale which would not have otherwise been made by enabling the shopper to negotiate a better price with the retailer.
2. The retailer is able to mitigate the effectiveness of price competition. For example, competitors cannot predict the pricing of an item such as item 112, which hinders the ability of the competitors to offer competitive pricing.
3. Enabling the retailer to attain specific sales goals with maximum margins, such as selling specified numbers of units in a specified time period, generating specified levels of revenue in a specified time period, or generating specified profit levels in a specified time period.
4. Enable more effective management of inventory levels.

The present invention improves a traditional retail “brick-and-mortar” store's profitability by reducing the effectiveness of price comparison shopping through the introduction of beneficial price uncertainty. For example, via application 146 running on a WCD, system 100 provides a means for in-store shoppers to negotiate a lower price on selected items.

Shoppers use system 100 and a WCD to identify a selected item and then negotiate an “option” to purchase a good or service from the store at an agreed upon price. The shopper is not committed to purchasing the item and does not incur a premium. The option expires when the shopper leaves the store. When a shopper decides to checkout with items purchased through system 100, system 100 sends to the shopper's WCD the unique information necessary to redeem the negotiated savings using the store's existing point-of-sale system.

During the negotiation process, system 100 transmits pricing signals, in the form of offers 116, to the shopper to indicate the approximate value of the target price. The real-time demand data captured by the negotiation process as respective items are purchased, optimizes the development and utilization of target prices going forward, for example, updating F1, F2, and F3. After savings associated with purchase of item 112 have been redeemed at checkout, system 100 determines the success of the sale and the current target price in attaining a predetermined goal, such as satisfying condition 144. If the results are not satisfactory, system 100 can modify the target price accordingly, for example, as described for FIGS. 3A through 3C.

By concealing target prices, a retailer may publish list prices or other prices higher than the target price to attract shoppers to their store with the promise of getting an even better price through negotiation. Further, competitors can no longer guarantee that they have a lower price, since the ultimate price at which an item may be available through system 100 cannot be predicted. For the retailer and the shopper the price uncertainty is mutually beneficial.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-based method for negotiating a price, comprising:
storing, in at least one memory element of at least one computer, computer readable instructions; and,
executing, using at least one processor for the at least one computer, the computer readable instructions to:
generate a target price for a first item available for purchase at a first retail sales location for a business entity;
generate a plurality of offers greater than the target price; and,
implement at least one iteration of a sequence including:
transmitting a respective offer from the plurality of offers;
receiving, from a first wireless communications device (WCD) in the first retail sales location, a respective counter-offer less than the respective offer; and,
transmitting, for receipt by the first WCD: a rejection of the respective counter-offer; an acceptance of the respective counter-offer; or a message that a negotiation for the first item is terminated.

2. The computer-based method of claim 1, further comprising executing, using the at least one processor, the computer readable instructions to:
receive a respective counter-offer at least equal to the target price; and,
transmit, for receipt by the first WCD, the acceptance of the respective counter-offer.

3. The computer-based method of claim 1, further comprising executing, using the at least one processor, the computer readable instructions to:
generate a sales history for the first item, over a first time period, including:
purchases of the first item based on respective accepted counter-offers; and,
a respective price for each purchase; and,
select the target price using the sales history.

4. The computer-based method of claim 3, further comprising executing, using the at least one processor, the computer readable instructions to:
accept a selection of an economic parameter; and,
select a selection of a condition of the economic parameter, wherein selecting the target price using the sales history includes:
determine a respective price from the sales history at which the condition of the economic parameter is satisfied; and,
selecting the respective price as the target price.

5. The computer-based method of claim 4, wherein the economic parameter is sale of a specified number of units of the first item within a second time period, the method further comprising executing, using the at least one processor, the computer readable instructions to generate a function representing the sales history, the function including:
a first variable representing respective prices paid per unit of the first item; and,
a second variable representing respective numbers of units of the first item sold per the second time period, wherein:
determining the respective price from the sales history at which the condition of the economic parameter is satisfied includes:
selecting a value for the second variable corresponding to the specified number of units; and,
selecting a value for the first variable corresponding to the value for the second variable; and,
selecting the respective price as the target price includes selecting the value for the first variable as the target price.

6. The computer-based method of claim 4, wherein the economic parameter is a specified amount of revenue from sales of the first item within a second time period, the method further comprising executing, using the at least one processor, the computer readable instructions to:
generate a function representing revenue generated by sales of the first item, the function including:
a first variable representing respective prices paid per unit of the first item; and,
a second variable representing respective revenues generated per value of the first variable, wherein:
determining the respective price from the sales history at which the condition of the economic parameter is satisfied includes:
selecting a value for the second variable corresponding to the specified amount of the revenue; and,
selecting a value for the first variable corresponding to the value for the second variable; and,
selecting the respective price as the target price includes selecting the value for the first variable as the target price.

7. The computer-based method of claim 4, wherein the economic parameter is a specified profit from sales of the first item within a second time period, the method further comprising executing, using the at least one processor, the computer readable instructions to:
generate a function representing profit generated by sales of the first item, the function including:
a first variable representing respective prices paid per unit of the first item; and,
a second variable representing respective profits generated per value of the first variable, wherein:
determining the respective price from the sales history at which the condition of the economic parameter is satisfied includes:
selecting a value for the second variable corresponding to the specified profit; and,
selecting a value for the first variable corresponding to the value for the second variable; and,
selecting the respective price as the target price includes selecting the value for the first variable as the target price.

8. The computer-based method of claim 1, further comprising executing, using the at least one processor, the computer readable instructions to confirm that the first WCD is located in the first retail sales location and wherein implementing the at least one iteration of the sequence includes implementing the at least one iteration only when the first WCD is confirmed as being in the first retail sales location.

9. The computer-based method of claim 1, further comprising executing, using the at least one processor, the computer readable instructions to:
receive from a second WCD, a request to implement the sequence;
determine that a location for the second WCD is a second retail sales location for which the sequence is not enabled; and,
transmit for receipt by a second business entity associated with the second retail sales location, a message that a request was made to implement the sequence at the second retail sales location.

10. A computer-based system for negotiating a price, comprising:
at least one memory element of at least one computer configured to store computer readable instructions; and,
at least one processor for the at least one computer arranged to execute the computer readable instructions to:
generate a target price for a first item available for purchase at a first retail sales location for a business entity;
generate a plurality of offers greater than the target price; and,
implement at least one iteration of a sequence including:
transmitting a respective offer from the plurality of offers;
receiving, from a first wireless communications device (WCD) in the first retail sales location, a respective counter-offer less than the respective offer; and,
transmitting, for receipt by the first WCD: a rejection of the respective counter-offer; an acceptance of the respective counter-offer; or a message that a negotiation for the first item is terminated.

11. The computer-based system of claim 10, wherein generate a plurality of offers greater than the target price includes generating the plurality of offers such that for each subsequent iteration of the sequence, a difference between the respective offer in a current iteration and the respective offer in an immediately preceding iteration decreases.

12. The computer-based system of claim 10, wherein the at least one processor is arranged to execute the compute readable instructions to:
receive a respective counter-offer at least equal to the target price; and,
transmit, for receipt by the first WCD, the acceptance of the respective counter-offer.

13. The computer-based system of claim 10, wherein the at least one processor is arranged to execute the compute readable instructions to:
generate a sales history for the first item over a first time period, the sales history including:
purchases of the first item based on respective accepted counter-offers; and,
a respective price for each purchase; and,
select the target price using the sales history.

14. The computer-based system of claim 13, wherein:
the at least one processor is arranged to execute the compute readable instructions to:
accept a selection of an economic parameter; and,
select a selection of a condition of the economic parameter; and,
selecting the target price using the sales history includes:
determine a respective price from the sales history at which the condition of the economic parameter is satisfied; and,
selecting the respective price as the target price.

15. The computer-based system of claim 14, wherein:
the economic parameter is sale of a specified number of units of the first item within a second time period;
the at least one processor is arranged to execute the compute readable instructions to generate a function representing the sales history, the function including:
a first variable representing respective prices paid per unit of the first item; and,
a second variable representing respective numbers of units of the first item sold per the second time period;
determining the respective price from the sales history at which the condition of the economic parameter is satisfied includes:
selecting a value for the second variable corresponding to the specified number of units; and,
selecting a value for the first variable corresponding to the value for the second variable; and,
selecting the respective price as the target price includes selecting the value for the first variable as the target price.

16. The computer-based system of claim 14, wherein:
the economic parameter is a specified amount of revenue from sales of the first item within a second time period;
the at least one processor is arranged to execute the compute readable instructions to generate a function representing revenue generated by sales of the first item, the function including:
a first variable representing respective prices paid per unit of the first item; and,
a second variable representing respective revenues generated per value of the first variable;
determining the respective price from the sales history at which the condition of the economic parameter is satisfied includes:
selecting a value for the second variable corresponding to the specified amount of revenue; and,
selecting a value for the first variable corresponding to the value for the second variable; and,
selecting the respective price as the target price includes selecting the value for the first variable as the target price.

17. The computer-based system of claim 14, wherein:
the economic parameter is a specified profit from sales of the first item within a second time period;
the at least one processor is arranged to execute the compute readable instructions to generate a function representing profit generated by sales of the first item, the function including:
a first variable representing respective prices paid per unit of the first item; and,
a second variable representing respective profits generated per value of the first variable, wherein:
determining the respective price from the sales history at which the condition of the economic parameter is satisfied includes:
selecting a value for the second variable corresponding to the specified profit; and,
selecting a value for the first variable corresponding to the value for the second variable; and,
selecting the respective price as the target price includes selecting the value for the first variable as the target price.

18. A computer-based system for negotiating a price, comprising:
at least one memory element of at least one computer configured to store computer readable instructions; and,
at least one processor for the at least one computer configured to execute the computer readable instructions to:
generate a sales history for a first item, available for purchase at a first retail sales location, over a first time period;
accept a selection of sale of units of the first item as an economic parameter;
accept a selection of sale of a specified number of units of the first item within a second time period as a condition of the economic parameter;
generate a target price for the first item;
generate a plurality of offers greater than the target price; and,
implement at least one iteration of a sequence including:
transmitting a respective offer from the plurality of offers;
receiving, from a wireless communications device (WCD) in the first retail sales location, a respective counter-offer less than the respective offer; and,
transmitting, for receipt by the WCD: a rejection of the respective counter-offer; an acceptance of the respective counter-offer; or a message that a negotiation for the first item is terminated, wherein:
the sales history includes:
purchases of the first item based on respective accepted counter-offers; and,
a respective price for each purchase;
generating a target price includes:
generating a function from the sales history including:
a first variable representing respective prices paid per unit of the first item; and,
a second variable representing respective numbers of units of the first item sold per the second time period;
determining a first value of the first variable at which the condition of the economic parameter is satisfied by:
selecting a second value for the second variable corresponding to the specified number of units; and,
selecting the first value as corresponding to the second value in the function; and,
selecting the first value as the target price.

19. A computer-based system for negotiating a price, comprising:
at least one memory element of at least one computer configured to store computer readable instructions; and,
at least one processor for the at least one computer configured to execute the computer readable instructions to:
generate a sales history for a first item, available for purchase at a first retail sales location, over a first time period;
accept a selection of a specified amount of revenue from sales of the first item as an economic parameter;
accept a selection of the specified amount of revenue within a second time period as a condition of the economic parameter;
generate a target price for the first item;
generate a plurality of offers greater than the target price; and,
implement at least one iteration of a sequence including:
transmitting a respective offer from the plurality of offers;
receiving, from a wireless communications device (WCD) in the first retail sales location, a respective counter-offer less than the respective offer; and,
transmitting, for receipt by the WCD: a rejection of the respective counter-offer; an acceptance of the respective counter-offer; or a message that a negotiation for the first item is terminated, wherein:
the sales history includes:
purchases of the first item based on respective accepted counter-offers; and,
a respective price for each purchase;
generating a target price includes:
generating a function from the sales history including:
a first variable representing respective prices paid per unit of the first item; and,
a second variable representing respective revenues generated per value of the first variable;
determining a first value of the first variable at which the condition of the economic parameter is satisfied by:
selecting a second value for the second variable corresponding to the specified amount of the revenue; and,
selecting the first value as corresponding to the second value in the function; and,
selecting the first value as the target price.

20. A computer-based system for negotiating a price, comprising:
at least one memory element of at least one computer configured to store computer readable instructions; and,
at least one processor for the at least one computer configured to execute the computer readable instructions to:
generate a sales history for a first item, available for purchase at a first retail sales location, over a first time period;
accept a selection of the specified profit within a second time period as an economic parameter;
accept a selection of sale of a specified number of units of the first item within a second time period as a condition of the economic parameter;
generate a target price for the first item;
generate a plurality of offers greater than the target price; and,
implement at least one iteration of a sequence including:
transmitting a respective offer from the plurality of offers;
receiving, from a wireless communications device (WCD) in the first retail sales location, a respective counter-offer less than the respective offer; and,
transmitting, for receipt by the WCD: a rejection of the respective counter-offer; an acceptance of the respective counter-offer; or a message that a negotiation for the first item is terminated, wherein:
the sales history includes:
purchases of the first item based on respective accepted counter-offers; and,
a respective price for each purchase;
generating a target price includes:
generating a function from the sales history including:
a first variable representing respective prices paid per unit of the first item; and,
a second variable representing respective profits generated per value of the first variable;
determining a first value of the first variable at which the condition of the economic parameter is satisfied by:
selecting a second value for the second variable corresponding to the specified profit a second variable representing respective profits generated per value of the first variable; and,
selecting the first value as corresponding to the second value in the function; and,
selecting the first value as the target price.
